(19) United States
(12) Patent Application Publication
(10) Pub. No.: US 2026/0289757 A1
(43) Pub. Date: Sep. 24, 2026

(54) VIDEO COMPARISON FOR EVALUATION OF COMPUTER GRAPHICS SYSTEMS

(71) Applicant: NVIDIA Corporation, Santa Clara, CA (US)

(72) Inventors: Budmonde Duinkharjav, Queens, NY (US); Loudon Cohen, San Francisco, CA (US); Anjul Patney, Kirkland, WA (US)

(21) Appl. No.: 19/087,426

(22) Filed: Mar. 21, 2025

(51) Int. Cl. G06T 7/00; G06T 13/20

(52) U.S. Cl. CPC G06T 7/0002; G06T 13/20; G06T 2200/24; G06T 2207/10016; G06T 2207/20104; G06T 2207/30168

(57) ABSTRACT

Disclosed are apparatuses, systems, and techniques that facilitates the efficient, automated comparison of computer graphics systems and algorithms. The techniques include comparing a first set of video artifacts and a second set of video artifacts. The sets of video artifacts may have been derived from respective videos generated by a respective computer graphics system. The techniques include determining, based on the comparing, that a difference between a first video artifact and a second video artifact satisfy a threshold criterion, indicating that the video artifacts have one or more similar characteristics. The techniques include causing a UI to play a first portion of the first video that includes the first video artifact and a second portion of the second video that includes the second video artifact.

### TECHNICAL FIELD

At least one embodiment pertains to computer graphics systems and algorithms. For example, at least one embodiment pertains to systems and techniques that facilitate efficient, automated comparison of computer graphics systems and algorithms.

### BACKGROUND

Computer graphics systems are used to create and manipulate images with the aid of computers. Such systems encompass a wide range of techniques, from 2D image editing and animation to 3D modeling and rendering. Computer-generated imagery can sometimes contain artifacts, which may include imperfections, rendering errors or other unintended content.

### BRIEF DESCRIPTION OF THE DRAWINGS

FIG. 1 is a block diagram of an example computer system capable of performing video comparisons for the evaluation of computer graphics systems, according to at least one embodiment;

FIG. 2 illustrates an example computing device that supports performing video comparisons for the evaluation of computer graphics systems, according to at least one embodiment;

FIG. 3A illustrates an example data flow for performing video comparisons for the evaluation of computer graphics systems, according to at least one embodiment;

FIG. 3B illustrates another example data flow for performing video comparisons for the evaluation of computer graphics systems, according to at least one embodiment;

FIG. 4A illustrates an example user interface for performing video comparisons for the evaluation of computer graphics systems, according to at least one embodiment;

FIG. 4B illustrates another example user interface for performing video comparisons for the evaluation of computer graphics systems, according to at least one embodiment;

FIG. 5 is a flow diagram of a method for performing video comparisons for the evaluation of computer graphics systems, according to at least one embodiment;

FIG. 6 is a flow diagram of another method for performing video comparisons for the evaluation of computer graphics systems, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment;

FIG. 11A is a block diagram of an example generative language model system suitable for use in implementing at least some embodiments of the present disclosure;

FIG. 11B is a block diagram of an example embodiment in which the generative LM includes a transformer encoder-decoder, according to at least one embodiment;

FIG. 11C is a block diagram of an example embodiment in which the generative LM 1130 includes a decoder-only transformer architecture, according to at least one embodiment;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Computer graphics systems, software, and/or algorithms generate computer imagery to be used in a variety of applications. One challenge facing such computer graphics systems, etc. is comparing the quality of the generated computer imagery, where the comparison may be between computer imagery generated using different methods. While software can measure certain aspects of computer-generated imagery quality, other aspects are more discernible by humans. Thus, part of the process of comparing computer graphics systems, software, and/or algorithms involves a human comparing and evaluating the outputs of such systems, software, and/or algorithms. However, presenting two videos that include clips of the same content rendered by different computer graphics systems, etc. to the human evaluator is very inefficient. The videos can be several minutes long and contain large amounts of visual content that could potentially be reviewed by the evaluator. Furthermore, the content that the evaluator should focus on during a comparison may be difficult for the evaluator to detect because the content may be focused on a smaller region compared to the entire video frame, or the content may only occur for a short amount of time (e.g., only a couple of video frames).

Aspects and embodiments of the present disclosure address these and other challenges related to comparing computer-generated imagery by providing systems and techniques for selecting portions of videos for presentation to a human evaluator. The videos can include video content rendered by different computer graphics systems, software, and/or algorithms. The selected video portions contain isolated portions of the videos that are most likely to be different from one another. The human evaluator can then observe playback of the video portions to efficiently compare the quality of the different computer graphics systems, software, etc.

The systems and techniques obtain multiple videos. Each video may include video data generated by a computer graphics system, software, and/or algorithm. The video data may include computer-generated animation, video game gameplay, a pre-rendered cutscene of a video game, or other computer-generated imagery. The different videos may include a rendering of the same content (e.g., the same animation, the same portion of a video game gameplay, or the same pre-rendered cutscene) generated by different computer graphics systems, software, and/or algorithms.

The systems and techniques may provide the videos to a computational model. The computational model may identify portions of a video that may contain video artifacts. A video artifact may include a rendering error or other content that a human evaluator may want to examine more closely. Examples of artifacts include ghosting (faint, duplicate images that appear slightly offset from the original), flickering (rapid and/or inconsistent changes in brightness or color within a scene), pixelation, and jagged edges of objects. The output of the computational model may include data identifying the portions of the video that contain artifacts. The portions of the video may include one or more cropped versions of the video (spatial portions), one or more trimmed version of the video (temporal portions), and/or one or more clips of the video (short segments from the video). The computational model may generate an output for each video.

The systems and techniques may compare the computational model outputs for different videos to determine the portions of those video that exhibit differences in artifacts. For example, the computational model may indicate that a first video contains flickering in an upper-left portion of the video from time 01:56-01:59 while a second video does not contain flickering in that area of the video at substantially the same time period. The systems and techniques of the present disclosure may identify this difference in artifacts and may select that portion of each video as a video portion to be presented to a human evaluator. In another example, the computational model may indicate that both the first and second videos contain ghosting in a top portion of the video from time 2:45-2:46. The systems and techniques of the present disclosure may determine that these portions of the videos are sufficiently similar such that they may not be presented to the human evaluator.

The systems and techniques may use a comparison of the computation model outputs rather than using the model outputs directly because some videos may include content that the computational model may incorrectly identify as an artifact. For example, a video may include a lightbulb that intentionally flickers. The computational model may identify that portion of the video as containing a flickering artifact even though the flickering is intentional.

The systems and techniques may use a difference threshold to identify corresponding portions of videos that are sufficiently different and, as such, designated for presentation to a human evaluator for comparison. For example, the computational model may identify ghosting at the same location and at the same time in two input videos. However, the output corresponding to the first video may indicate a higher amount of ghosting than the output corresponding to the second video. If the amount of ghosting in the first video exceeds the amount of ghosting by the difference threshold, the systems and techniques of the present disclosure can determine that these portions of the videos are to be presented to a human evaluator for comparisons. Systems and techniques using a more conservative approach may have a lower difference threshold than other approaches.

For some types of video content (e.g., video game gameplay), different videos containing the same content may be offset temporally and/or spatially. For example, two different playthroughs of the same portion of a video game may use different camera angles, player actions, etc. The systems and techniques of the present disclosure can compare the videos and determine which portions of the videos correspond to each other even if the portions are not identical. The systems and techniques can then compare the computational model outputs for the corresponding portions to identify differences, taking into account spatial and temporal differences of the videos.

After the systems and techniques have identified the portions of the different videos that are to be evaluated by the human evaluator, the identified portions of the videos are presented on a user interface (UI). The UI may include two or more video portions. The videos may be shown side-by-side, in a grid layout, or in some other layout. The video portions may be synchronized so they show the same content at the same time. The UI may play back the video portions so the human evaluator can view the video playback and compare the quality of the content. The playback may include the video portions being played forward and backwards, looping, or in some other playback manner. The UI may include UI elements that allow the human evaluator to control certain aspects of the playback or the video portions (e.g., zooming in or out, adjusting the playback speed, etc.).

The advantages of the disclosed techniques include, but are not limited to, improved accuracy in identifying differences in videos rendered by different computer graphics systems, software, and/or algorithms. The identified differences can be isolated for presentation to an evaluating user, which makes it easier and more efficient for the user to evaluate the quality of the systems, software, and/or algorithms. Thus, the user's experience with the video comparison system is improved.

### System Architecture

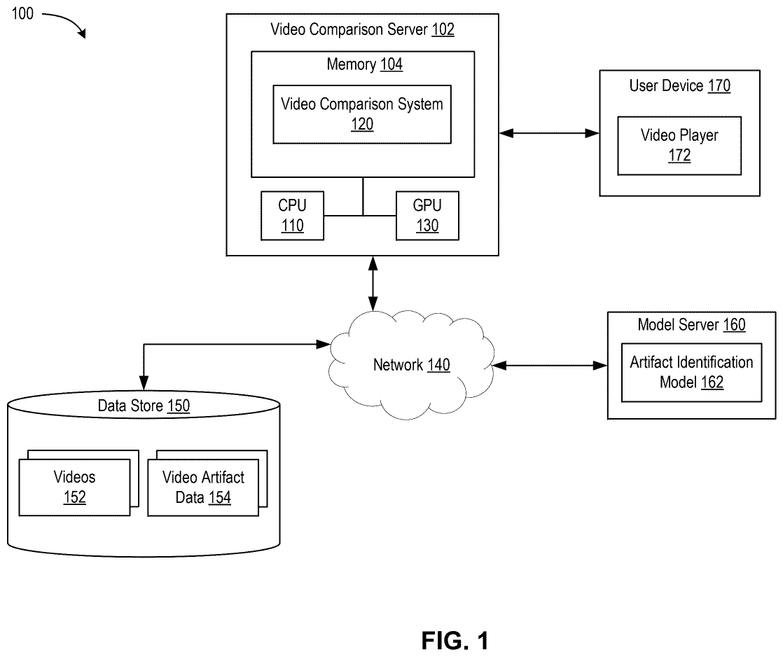

FIG. 1 is a block diagram of an example computer system 100 capable of performing video comparisons for the evaluation of computer graphics systems, in accordance with at least some embodiments. As depicted in FIG. 1, a computer system 100 may include a video comparison server 102, a data store 150, a model server 160, and a user device 170 connected to a network 140. The network 140 may be a public network (e.g., the Internet), a private network (e.g., a local area network (LAN), or wide area network (WAN)), a wireless network, a personal area network (PAN), a combination thereof, and/or another network type.

The video comparison server 102 may include a desktop computer, a laptop computer, a smartphone, a tablet computer, a server, a wearable device, a VR/AR/MR headset or head-up display, and/or any suitable computing device capable of performing the techniques described herein. The video comparison server 102 may be configured to receive video data and/or video artifact data. The video data and/or video artifact data may be retrieved from memory 104 of the video comparison server 102, and/or received over any local or network connection (e.g., via network 140) from an external computing device. In some embodiments, the video data and/or video artifact data may be stored (e.g., together with other data, such as metadata) in the data store 150 (e.g., as the videos 152 or the video artifact data 154). The data store 150 may be accessed by the video comparison server 102 directly or (as shown in FIG. 1) indirectly via the network 140.

The video comparison server 102 may include a memory 104 (e.g., one or more memory devices or units) communicatively coupled with one or more processing devices or processing circuitry, such as one or more central processing units (CPUs) 110, one or more graphics processing units (GPUs) 130, one or more data processing units (DPUs), one or more parallel processing units (PPUs), and/or other processing devices (e.g., field-programmable gate arrays (FPGAs), application-specific integrated circuits (ASICs), and/or the like). The memory 104 may store one or more components and models, such as a video comparison system 120 capable of comparing video artifact data 154 from different videos 152 and determining that a difference between the video artifacts satisfies a threshold criterion and, thus, portions of the different videos 152 are to be played for a human evaluator.

The data store 150 may include a persistent storage capable of storing audio files and/or other media files as well as metadata for the stored files. The data store 150 may be hosted by one or more storage devices, such as main memory, magnetic or optical storage disks, tapes, or hard drives, network-attached storage (NAS), storage area network (SAN), and so forth. Although depicted as separate from the video comparison server 102, in at least some embodiments, the data store 150 may be a part of the video comparison server 102. In at least some embodiments, the data store 150 may be a network-attached file server, while in other embodiments, the data store 150 may be some other type of persistent storage such as an object-oriented database, a relational database, and so forth, that may be hosted by a server machine or one or more different machines coupled to the video comparison server 102 via the network 140.

The data store 150 may store one or more videos 152. Each video may include content generated or rendered by a certain computer graphics system, software, and/or algorithm. The content may include computer-generated imagery, which may include 2D or 3D imagery. The content may include computer-generated animation, video of video game gameplay, a pre-rendered cutscene, or other computer-generated imagery. In one example, a first video 152 may include content rendered by Graphics System A, and a second video 152 may include content rendered by Graphics System B. In some embodiments, different videos 152 may include content rendered by the different versions of the same computer graphics system, software, and/or algorithm. For example, a first video 152 may include content generated by Graphics System A version 1.2, and a second video 152 may include content generated by Graphics System A version 1.3.

In some embodiments, a video 152 may include one or more video artifacts. A video artifact may include a visual anomaly or imperfection that appears in a video 152. Examples of video artifacts can include ghosting, flickering, pixelation, and/or jagged edges of objects. Ghosting may include faint, duplicate images that appear slightly offset from the original image. Flickering may include rapid and/or inconsistent changes in brightness or color within a scene. Pixelation may include visible squares or blocks of color that may be particularly noticeable in areas of high detail or rapid motion. The data store 150 may store video artifact data 154. Video artifact data 154 may include data that temporally and/or spatially identifies one or more video artifacts in a respective video 152. As discussed below, a video artifact may include a video artifact identified by a computational model that identifies video artifacts in video data.

In some embodiments, the model server 160 may include a desktop computer, a laptop computer, a smartphone, a tablet computer, a server, and/or any suitable computing device capable of performing the techniques described herein. The model server 160 may store and/or execute one or more artifact identification models 162. An artifact identification model 162 may include a computational model trained and/or programmed to identify video artifacts in video data input into the model 162 (e.g., one or more of the videos 152). The artifact identification model 162 may include a video object detection model that analyzes the frames of an input video 152 and locates video artifacts within the frames.

In one embodiment, training of the artifact identification model 162 may be performed using training data (e.g., video data) that may be annotated with ground truths, e.g., correct identifications of video artifacts in the training data. During training, predictions of the model 162 may be compared with ground truths. More specifically, a training engine (not shown in FIG. 1) may cause the model to process training inputs, which may include one or more items of training data, and generate training outputs, which represent outputs in the corresponding training inputs. During training, the training engine may also generate mapping data (e.g., metadata) that associates training inputs with correct target outputs. Target outputs may include ground truths for corresponding training inputs. Training causes the model 162 to identify patterns in training inputs based on desired target outputs and learn to accurately classify input data.

Initially, edge parameters (e.g., weights and biases) of the artifact identification model 162 may be assigned some starting (e.g., random) values. For every training input, the training engine may compare the training output with the corresponding target output. The resulting error or mismatch, e.g., the difference between the desired target output and the generated training output of the model 162, may be backpropagated through the model 162 and at least some parameters of the model 162 may be changed in a way that brings training output closer to target output. Such adjustments may be repeated until the output error for a given training input satisfies a predetermined condition (e.g., falls below a predetermined error). Subsequently, a different training input may be selected, a new training output generated, and a new series of adjustments implemented, until the model is trained to a target degree of precision or until the model converges to a limit of its (architecture-determined) accuracy. The model server 160 may train any number of artifact identification models 162 using suitable sets of training inputs and target outputs. The trained models 162 may be stored on the model server 160 or in the data store 150, and models 162 may be deployed on the model server 160 or the video comparison server 102.

In some embodiments, for efficient training, dropout techniques may be used for at least some of the training epochs, with outputs of at least some neurons removed (e.g., replaced with zero outputs). This forces the remaining neurons to learn how to perform content detection tasks more efficiently and generate more accurate outputs. In the course of training, different neurons (e.g., randomly chosen neurons) may be dropped during processing of different batches of training data, so that all neurons learn to perform tasks more accurately and efficiently.

In one embodiment, the user device 170 may include a desktop computer, a laptop computer, a smartphone, a tablet computer, a server, and/or any suitable computing device capable of performing the techniques described herein. The user device 170 may include a UI that includes a video player 172. The video player 172 may play portions of videos 152 that the video comparison system 120 identifies as having video artifacts whose differences satisfy a threshold criterion. A user of the user device 170 may view those identified portions of the videos 152 and evaluate the quality of each of the videos 152.

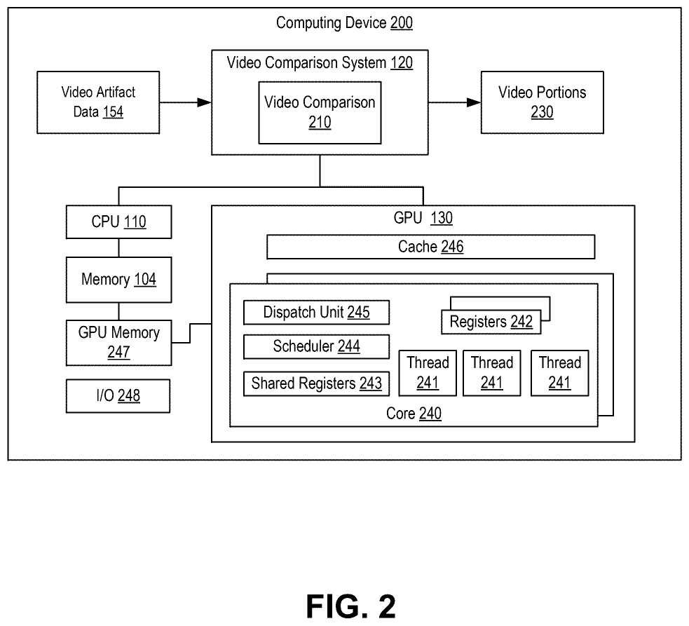

FIG. 2 illustrates an example computing device 200 that supports performing video comparisons for the evaluation of computer graphics systems, according to at least one embodiment. In at least one embodiment, the computing device 200 may be a part of the video comparison server 102. As seen in FIG. 2, the computing device 200 may include the video comparison system 120, which may use the video artifact data 154 as input, determine which portions of the videos 152 that have video artifacts whose differences satisfy a threshold criterion, and output data indicating those video portions 230. The video comparison system 120 may include a video comparison module 210, which may perform the comparison of the video artifacts and determine whether their differences satisfy a threshold criterion.

In some embodiments, operations of the video comparison system 120 may be executed using one or more CPUs 110, one or more GPUs 130, one or more parallel processing units (PPUs) or accelerators, such as a deep learning accelerator, data processing units (DPUs), and/or the like. In at least one embodiment, a GPU 130 includes multiple cores 240, each core 240 being capable of executing multiple threads 241. Each core 240 may run multiple threads 241 concurrently (e.g., in parallel). In at least one embodiment, threads 241 may have access to registers 242. Registers 242 may be thread-specific registers with access to a register restricted to a respective thread 241. Additionally, shared registers 243 may be accessed by one or more (e.g., all) threads 241 of the core 240. In at least one embodiment, individual cores 240 may include a scheduler 244 to distribute computational tasks and processes among different threads 241 of core 240. A dispatch unit 245 may implement scheduled tasks on appropriate threads 241 using correct private registers 242 and shared registers 243. The computing device 200 may include input/output component(s) 248 to facilitate exchange of information with one or more users or developers.

In at least one embodiment, the GPU 130 may have a (high-speed) cache 246, access to which may be shared by any, some, or all cores 240. Furthermore, the computing device 200 may include a GPU memory 247 where the GPU 130 may store intermediate and/or final results (outputs) of various computations performed by the GPU 130. After completion of a particular task, the CPU 110 or the GPU 130 may move the output to (main) memory 104. In at least one embodiment, the CPU 110 may execute processes that involve serial computational tasks whereas the GPU 130 may execute tasks (such as multiplication of inputs of a neural node by weights and addition of biases) that are amenable to parallel processing. In at least one embodiment, a CPU 110 may determine which processes are to be executed on a GPU 130 and which processes are to be executed on a CPU 110.

### Video Comparison of Computer Graphics Systems

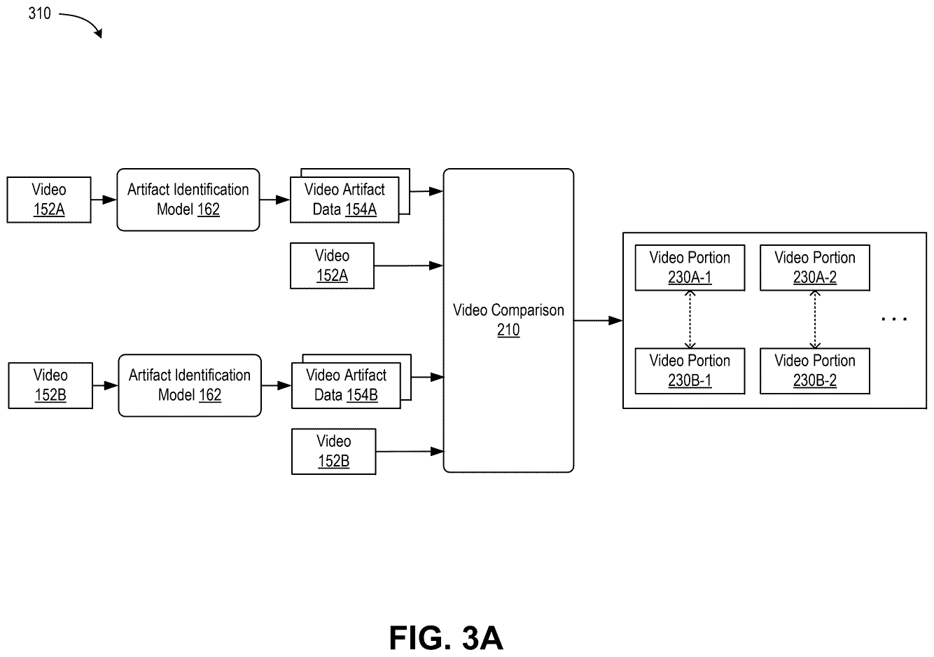

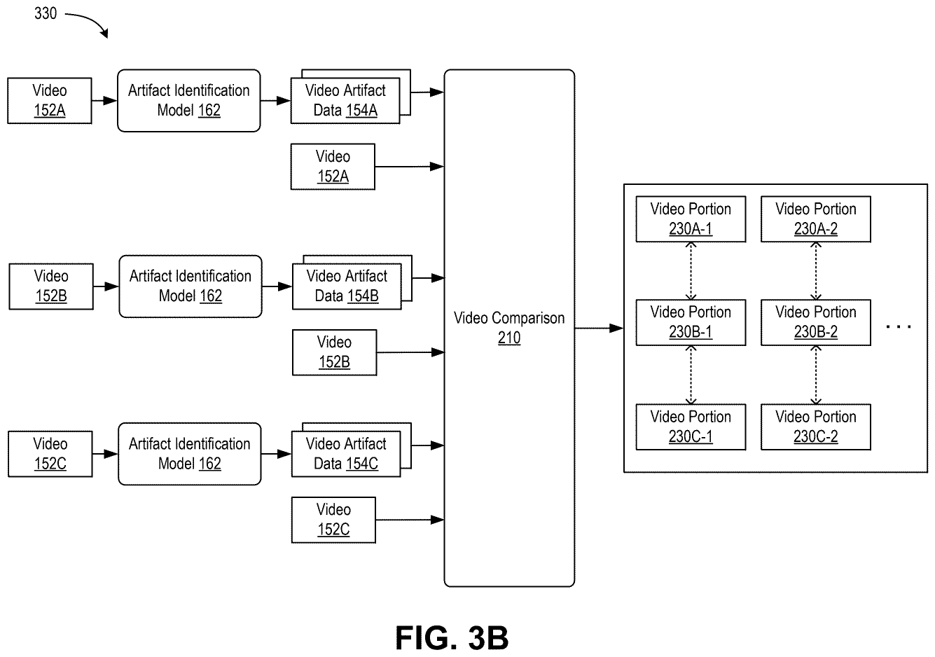

FIG. 3A illustrates an example data flow 310 for performing video comparisons for the evaluation of computer graphics systems, according to at least one embodiment. In at least one embodiment, the data flow 310 may be implemented as part of the video comparison server 102 of FIGS. 1 and 2, which may be located on a single computing device or on multiple computing devices. The data flow 310 may be coordinated by the video comparison system 120.

As illustrated in FIG. 3A, the data flow 310 may include a first video 152A and a second video 152B. The first and second videos 152A-152B may include videos depicting the same content generated by different computer graphics systems, software, or algorithms. In one implementation, a user (e.g., the user of the user device 170) may provide input to the video comparison system 120 indicating the first and second videos 152A-152B.

The video comparison system 120 may provide, as input to the artifact identification model 162, the first video 152A. The artifact identification model 162 may generate, using the first video 152A, first video artifact data 154A. As discussed above in relation to FIG. 1, the artifact identification model 162 may include a computational model trained and/or programmed to identify video artifacts in an input video 152. The first video artifact data 154A may include data indicating a set of video artifacts identified in the first video 152A. The data indicating the set of video artifacts may include, for each video artifact, data indicating: the temporal location(s) of the video artifact in the first video 152A, the spatial location(s) of the video artifact in the first video 152A, and/or the type of video artifact.

The data indicating the temporal location(s) of the video artifact may include data indicating when the video artifact is present in the first video 152A. Such data may include one or more timestamps, a time range, frame numbers, or other data indicating the time(s) at which the video artifact is present in the first video 152A. The data indicating the spatial location(s) of the video artifact may include data indicating where the video artifact is present in the first video 152A. Such data may include one or more bounding boxes or other data indicating the location of the data artifact in a frame of the first video 152A, the frame(s) associated with the one or more bounding boxes, or other data indicating the location(s) at which the video artifact is present in the first video 152A. The data indicating the type of video artifact may include data identifying the video artifact as ghosting, flickering, pixelation, etc.

The video comparison system 120 may provide, as input to the artifact identification model 162, the second video 152B. The artifact identification model 162 may generate, using the second video 152B, second video artifact data 154B. Similar to the first video artifact data 154A, the second video artifact data 154B may include data indicating a set of video artifacts identified in the second video 152B, which may include, for each video artifact, data indicating: the temporal location(s) of the video artifact in the second video 152B, the spatial location(s) of the video artifact in the second video 152B, and/or the type of video artifact.

The video comparison system 120 may provide the first video artifact data 154A and the second video artifact data 154B to the video comparison module 210. The video comparison module 210 may determine which video artifacts of the first video artifact data 154A correspond to which video artifacts of the second video artifact data 154B, or vice versa. Determining that a first video artifact of the first video artifact data 154A corresponds to a second video artifact of the second video artifact data 154B may include determining that the first video artifact and the second video artifact have one or more similar characteristics.

In one embodiment, the first video artifact and the second video artifact having one or more similar characteristics may include the first video artifact and the second video artifact occurring during the same content depicted in the first video 152A and the second video 152B. The video comparison module 210 may use the first and second video artifacts to determine whether the video portions during which the first and second artifacts occur depict the same content.

As an example, the first and second videos 152A-152B may include video of video game gameplay, and part of the gameplay may include a character jumping. Ghosting (one type of video artifact) may occur during the jumping and may be present in both the first video 152A and the second video 152B. The artifact identification model 162 may identify the ghosting video artifacts in the first and second videos 152A-152B, and the model 162 may generate the first and second video artifact data 154A-154B. The first video artifact may include the ghosting video artifact as depicted in the first video 152A and may be indicated by the first video artifact data 154A, and the second video artifact may include the ghosting artifact as depicted in the second video 152B and may be indicated by the second video artifact data 154B. The video comparison module 210 may then use the first and second video artifacts to determine whether the portions of the first and second videos 152A-152B corresponding to the first and second video artifacts are sufficiently similar such that the first and second video artifacts occur during the same content. The video comparison module 210 may determine whether the portions of the first and second videos 152A-152B satisfy a visual similarity criterion. If so, the video comparison module 210 may determine that the first and second video artifacts occur during the same content and, thus, the first and second video artifacts have one or more similar characteristics.

In one embodiment, the first video artifact and the second video artifact having one or more similar characteristics may include the first video artifact and the second video artifact occurring within a threshold time period from each other during the first and second videos 152A-152B. As an example, the first artifact may occur during the time period 00:01:47-00:01:51 of the first video 152A, and the second artifact may occur during the time period 00:01:48-00:01:51 of the second video 152B. The threshold time period may include 2 seconds. Since the time period during which the first artifact occurred is within 2 seconds of the time period during which the second artifact occurred, the video comparison module 210 may determine that the first and second video artifacts have one or more similar characteristics.

In one embodiment, the first video artifact and the second video artifact having one or more similar characteristics may include the first video artifact and the second video artifact occurring within a threshold distance from each other during the first and second videos 152A-152B. The threshold distance may include a number of pixels, a percentage of a dimension of a frame of a video 152A-152B, or some other distance measurement. In some embodiments, the first video artifact and the second video artifact having one or more similar characteristics may include the first video artifact and the second video artifact being the same type of video artifact.

In some embodiments, the portion of the first video 152A that contains the first video artifact may be sufficiently similar to the portion of the second video that contains the second artifact such that these portions of the videos 152A-152B should not be presented to a human evaluator even though these portions depict video artifacts. In some cases, this may be because the computer graphics systems that generated the videos 152A-152B generate similar video artifacts. In other cases, this may be because these portions of the videos 152A-152B depict content that the artifact identification model 162 determines is a video artifact, but the content is purposeful. For example, the content may include a light that intentionally flickers, however, the artifact identification model 162 may incorrectly determine that the content contains a flickering video artifact. The video comparison module 210 may use a difference criterion to ignore such cases so the human evaluator is presented with portions of the videos 152A-152B that are different.

The video comparison module 210 may determine whether a difference between the first video artifact and the second video artifact satisfies a threshold criterion. In response to the difference between the first and second video artifacts not satisfying the threshold criterion, the video comparison module 210 may discard the first and second video artifacts. The threshold criterion may include the portion of the first video 152A that corresponds to the first video artifact and the portion of the second video 152B that corresponds to the second video artifact having a visual difference above a threshold visual difference value. The threshold difference value may include a means-squared error (MSE) value or some other value that quantifies a visual difference between corresponding portions of the first and second videos 152A-152B.

The video comparison module 210 may output one or more video portions 230. Each video portion 230 may include a portion of the first video 152A or the second video 152B. The portion of the video 152 may include a segment of the video 152 between specific timestamps. The portion of the video 152 may include one or more regions of interest (ROIs) within one or more frames of the video 152. An ROI may include a specific area within a frame. The area may include an area depicting a video artifact, as discussed below. The video portion 230 may be less than an entire frame of the video 152 so a viewing user can easily see the video artifact and is not distracted by non-artifact content of the video 152.

Each video portion 230 may depict a video artifact. A video portion 230 may correspond to another video portion 230 where the video artifacts depicted in the video portions 230 have one or more similar characteristics, as discussed above. For example, as depicted in FIG. 3A, the video portion 230A-1 may include a portion of the first video 152A and may contain a first video artifact, and the video portion 230B-1 may include a portion of the second video 152B and may contain a second video artifact with similar characteristics to the first video artifact. Similarly, the video portion 230A-2 may include a portion of the first video 152A containing a third video artifact, and the video portion 230B-2 may include a portion of the second video 152B containing a fourth video artifact with similar characteristics to the third video artifact. The output of the video comparison module 210 may include one or more such pairs of video portions 230A-1, . . . , 230A-n and 230B-1, . . . ,230B-n.

In some embodiments, the video comparison module 210 may output a video portion 230 from the first video 152A that does not have a corresponding video portion 230 from the second video 152B. This may be because the first video 152A contains a video artifact and the second video 152B does not contain the video artifact during the same content.

FIG. 3B illustrates another example data flow 330 for performing video comparisons for the evaluation of computer graphics systems, according to at least one embodiment. The data flow 330 may include one or more components of the data flow 310 of FIG. 3A. For example, the data flow 330 may include the first video 152A, the first video artifact data 154A, the second video 152B, the second video artifact data 154B, the video comparison module 210, the first video portions 230A-1, . . . 230A-n, and/or the second video portions 230B-1, . . . 230B-n.

The data flow 330 may further include a third video 152C. The first, second, and third videos 152A-152C may include videos depicting the same content generated by different computer graphics systems, software, or algorithms. The video comparison system 120 may provide, as input to the artifact identification model 162, the first video 152A, the second video 152B, and the third video 152C. The artifact identification model 162 may generate, using the respective videos 152A-152C, first video artifact data 154A, second video artifact data 154B, and third video artifact data 154C.

The video comparison system 120 may provide the first, second, and third video artifact data 154A-154C to the video comparison module 210. The video comparison module 210 may determine which video artifacts of the first video artifact data 154A correspond to which video artifacts of the second video artifact data 154B and/or the third video artifact data 154C. The video comparison module 210 may determine which video artifacts of the second video artifact data 154B correspond to which video artifacts of the first video artifact data 154A and/or the third video artifact data 154C. The video comparison module 210 may determine which video artifacts of the third video artifact data 154C correspond to which video artifacts of the first video artifact data 154A and/or the second video artifact data 154B. Determining that a video artifact of the first, second, or third video artifact data 154A-154C corresponds to a video artifact of a different set of video artifact data 154A-154C may include determining that the video artifacts have one or more similar characteristics. The video comparison module 210 may determine whether a difference between the video artifacts satisfies a threshold criterion, as discussed above.

The video comparison module 210 may output one or more video portions 230. Each video portion 230 may include a portion of the first video 152A, second video 152B, or the third video 152C. The portion of a video 152 may include a segment of the video 152 between specific timestamps. The portion of the video 152 may include one or more ROIs within one or more frames of the video 152. A video portion 230 may be less than an entire frame of the respective video 152 so a viewing user can easily see the depicted video artifact and is not distracted by non-artifact content. Each video portion 230 may depict a video artifact. A video portion 230 may correspond to another video portion 230 derived from another video 152 where the video artifacts depicted in the video portions have one or more similar characteristics, as discussed above. For example, as depicted in FIG. 3B, the video portion 230A-1 may include a portion of the first video 152A and may contain a first video artifact, the video portion 230B-1 may include a portion of the second video 152B and may contain a second video artifact with similar characteristics to the first video artifact, and the video portion 230C-1 may include a portion of the third video 152C and may contain a third video artifact. The output of the video comparison module 210 may include one or more such triplets of video portions 230A-1, . . . , 230A-n, 230B-1, . . . , 230B-n, and 230C-1, . . . , 230C-n. In some embodiments, the video comparison module 210 may output a video portion 230 from the first video 152A or a video portion 230 from the second video 152B that does not have a corresponding video portion 230 from the third video 152C. This may be because the first video 152A and the second video 152B contain respective video artifacts that the third video 152C does not contain during the same content.

In one embodiment, the video comparison system 120 may cause the video player 172 of the user device 170 of FIG. 1 to play corresponding video portions 230. A human evaluator using the user device 170 may view the video portions 230 and compare the video portions 230 to efficiently compare the quality of the different computer graphics systems, software, etc. that generated the videos 152A-152C from which the video portions 230 were derived.

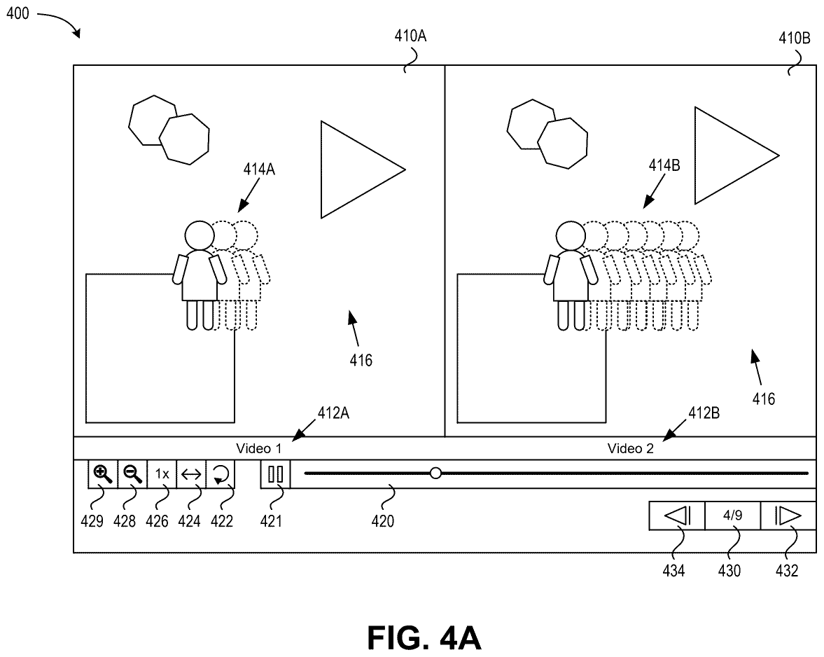

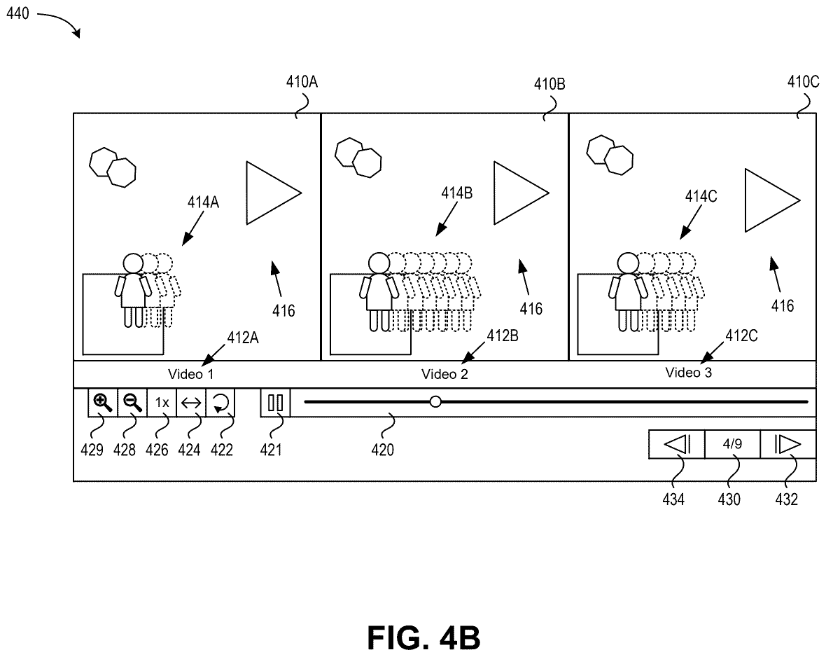

FIG. 4A depicts an example UI 400 for performing video comparisons for the evaluation of computer graphics systems, according to at least one embodiment. The UI 400 may include a UI for the video player 172 of the user device 170 of FIG. 1. The UI 400 may depict video portions 230 from different videos 152A-152B so a viewing user of the user device 170 can compare the quality of the different computer graphics systems, software, etc. that generated the videos 152A-152B.

As seen in FIG. 4A, the UI 400 may include a first video portion 410A and a second video portion 410B. The first video portion 410A may include a portion of the first video 152A, and the second video portion 410B may include a portion of the second video 152B. For example, the first video portion 410A may include the video portion 230A-1 of FIG. 3A, and the second video portion may include the video portion 230B-1 of FIG. 3A. The UI 400 may include a label 412A-412B disposed near a respective video portion 410A-410B. The label 412A-412B may include text or other data identifying the video 152A-152B from which the respective video portion 410A-410B is derived, the computer graphics system, software, etc. that generated the respective video 152A-152B, or other data.

A video portion 410 may depict a video artifact 414. For example, the first video portion 410A may depict a first video artifact 414A, and the second video portion 410B may depict a second video artifact 414B. The video artifacts 414A-414B may include one or more similar characteristics as determined by the video comparison module 210. For example, as seen in FIG. 4A, the two video portions 410A-410B depict the same content 416 and similar video artifacts 414A-414B (e.g., as seen in the example of FIG. 4A, both video artifacts 414A-414B depict a ghosting video artifact during the presentation of the same content 416). However, the video artifacts 414A-414B may be sufficiently different as determined by the video comparison module 210. For example, the ghosting of the second video artifact 414B has a longer trail. The video portions 410A-410B may play so a user can view the playback of the video portions 410A-410B. The playback of the video portions 410A-410B may be synchronized such that the video portions 410A-410B depict substantially the same content 416 with different video artifacts 414A-414B at substantially the same time.

In one embodiment, the UI 400 may further include one or more playback control elements that allow the viewing user to control how the video portions 410A-410B play. The UI 400 can include a seek bar 420. The seek bar 420 may include a slider that represents a duration of the video portions 410A-410B and allows the user to quickly navigate through the video portions 410A-410B. The UI 400 may include a pause/play UI element 421. Interacting with the pause/play UI element 421 may pause the playback of the video portions 410A-410B (if the video portions 410A-410B are currently playing) or may activate the playback of the video portions 410A-410B (if the video portions 410A-410B are currently paused).

The UI 400 may include a loop UI element 422. Interacting with the loop UI element 422 may cause the video portions 410A-410B to play in a loop. The UI 400 may include a forward-reverse UI element 424. Interacting with the forward-reverse UI element 424 may cause the video portions 410A-410B to play in alternating forward and backward directions. Playing the video portions 410A-410B in a forward-reverse manner may make it easier for the viewing user to see and evaluate certain video artifacts 414A-414B.

The UI 400 may include a playback speed UI element 426. Interacting with the playback speed UI element 426 may change the playback speed of the video portions 410A-410B. The playback speed may include a speed ranging from 0.25× (quarter speed) to 1× (normal speed) to 2× (double speed). The UI 400 may include a zoom out UI element 428 and a zoom in UI element 429, which may allow the user to zoom out on a video portion 410 or zoom in on a video portion 410. Other UI elements that may be included in the UI 400 may include a UI element that causes one or more of the video portions 410A-410B to appear full screen in the UI 400, a UI element that causes the UI 400 to hide one or more of the video portions 410A-410B, or other UI elements that control the playback or appearance of the video portions 410A-410B.

The UI 400 may include video portion selection UI elements that cause the UI 400 to display different video portions 410. For example, as seen in FIG. 4A, the UI 400 may include a video portion counter UI element 430. The video portion counter UI element 430 may display a progress counter that indicates the number of video portions 410 that are associated with the videos 152A-152B. The video portion counter UI element 430 may indicate which video portion pair the user is currently viewing. For example, as seen in FIG. 4A, the video portion counter UI element 430 displays “4/9,” indicating that the user is viewing the fourth set of video portions 410 out of nine video portions 410. The UI 400 may include a next video portions UI element 432, and interacting with the next video portions UI element 432 may cause the UI 400 to display the next pair of video portions 410. Similarly, the UI 400 may include a previous video portions UI element 434, and interacting with the previous video portions UI element 434 may cause the UI 400 to display a previous pair of video portions 410. The UI 400 may order the pairs of video portions 410 sequentially (e.g., in the order the video portions appear in the videos 152A-152B) or in some other order.

In some embodiments, the UI elements discussed above in relation to the UI 400 may include buttons, sliders, scroll bars, or other UI elements a user can interact with to control components of the UI 400. While FIG. 4A depicts the video portions 410A-410B disposed side-by-side, the layout of the UI 400 may include other configurations. For example, the first video portion 410A may be disposed above the second video portion 410B.

FIG. 4B depicts another example UI 440 for performing video comparisons for the evaluation of computer graphics systems, according to at least one embodiment. The UI 440 may include a UI for the video player 172 of the user device 170 of FIG. 1. The UI 440 may include one or more components of the UI 400 of FIG. 4A. For example, the UI 440 may include the first and second video portions 410A-410B, the labels 412A-412B, the seek bar 420, and/or one or more of the UI elements 421-434.

The UI 440 may further include a third video portion 410C. The third video portion 410C may include a portion of the third video 152C. For example, the third video portion 410C may include the video portion 230C-1 of FIG. 3B. The UI 440 may include a label 412C disposed near the third video portion 410C, which may include text or other data identifying the third video 152C from which the third video portion 410C is derived, the computer graphics system, software, etc. that generated the third video 152C, or other data.

The third video portion 410C may depict a third video artifact 414C. The video artifacts 414A-414C may include one or more similar characteristics as determined by the video comparison module 210. For example, as seen in FIG. 4B, the video portions 410A-410C depict the same content 416 and similar video artifacts 414A-414C (e.g., as seen in the example of FIG. 4B, the video artifacts 414A-414C depict a ghosting video artifact during the presentation of the same content 416). However, the video artifacts 414A-414C may be sufficiently different as determined by the video comparison module 210. For example, the ghostings of the video artifacts 414A-414C have different trail lengths. The video portions 410A-410C may play so a user can view the playback of the video portions 410A-410C. The playback of the video portions 410A-410C may be synchronized such that the video portions 410A-410C depict substantially the same content 416 with different video artifacts 414A-414C at substantially the same time.

While FIG. 4B depicts the video portions 410A-410C disposed side-by-side, the layout of the UI 440 may include other configurations. For example, the UI 440 may display the video portions 410A-410C in a stack, a grid, or some other layout. In some embodiments, the UI 440 may include four or more video portions 410 derived from respective videos 152 depicting substantially the same content 416 with respective video artifacts 414.

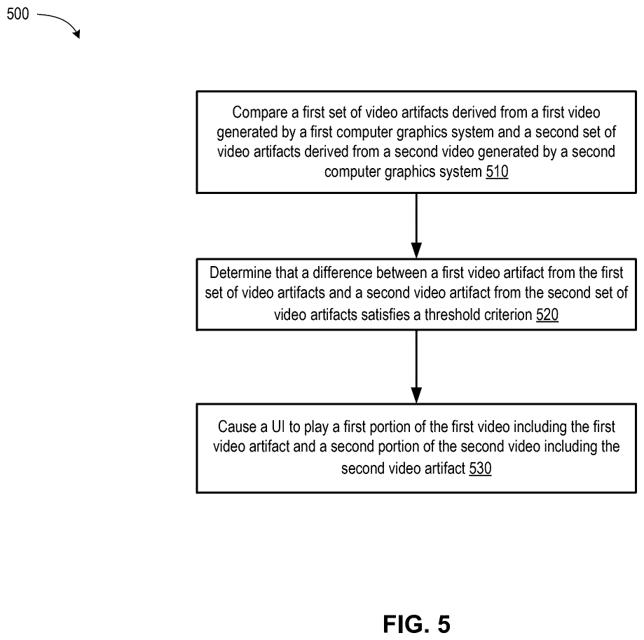

FIG. 5 is a flow diagram of a method 500 of performing video comparisons for the evaluation of computer graphics systems, according to at least one embodiment. The method 500 may be performed using one or more processing units or devices (e.g., CPUs, GPUs, accelerators, PPUs, DPUs, etc.), which may include (or communicate with) one or more memory devices. In at least one embodiment, the method 500 may be performed using processing units of the video comparison server 102. In at least one embodiment, the processing units performing the method 500 may be executing instructions stored on non-transient computer-readable storage media. In at least one embodiment, the method 500 may be performed using multiple processing threads (e.g., CPU threads and/or GPU threads), individual threads executing one or more individual functions, routines, subroutines, or operations of the method. In at least one embodiment, processing threads implementing the method 500 may be synchronized (e.g., using semaphores, critical sections, and/or other thread synchronization mechanisms). Alternatively, processing threads implementing the method 500 may be executed asynchronously with respect to each other. Some operations of the method 500 may be performed in a different order compared with the order shown in FIG. 5. Some operations of the method 500 may be performed concurrently with other operations. In at least one embodiment, one or more operations shown in FIG. 5 may not always be performed. One or more operations of the method 500 may be performed by video comparison system 120.

At block 510, processing logic compares a first set of video artifacts derived from a first video generated by a first computer graphics system and a second set of video artifacts derived from a second video generated by a second computer graphics system. The first set of video artifacts may include video artifacts indicated by the first video artifact data 154A of FIG. 3A, and the second set of video artifacts may include video artifacts indicated by the second video artifact data 154B of FIG. 3A. The first video generated by the first computer graphics system may include the first video 152A of FIG. 3A, the second video generated by the second computer graphics system may include the second video 152B of FIG. 3A. The first and second sets of video artifacts may include video artifacts identified by a computational model that identifies video artifacts in video data. For example, the computational model may include the artifact identification model 162 as discussed above in relation to FIG. 3A. Comparing the first set of video artifacts and the second set of video artifacts may include the video comparison module 210 comparing the first and second sets of video artifacts.

At block 520, processing logic determines, based on the comparing in block 510, that a difference between a first video artifact from the first set of video artifacts and a second video artifact from the second set of video artifacts satisfies a threshold criterion. The first video artifact and the second video artifact may have one or more similar characteristics. As discussed above in relation to FIG. 3A, the first video artifact and the second video artifact may occur during the same content depicted in the first video 152A and the second video 152B, the first and second video artifacts may occur within a threshold time period from each other during the first and second videos 152A-152B, or the first and second video artifacts may occur within a threshold distance from each other in one or more frames of the first and second videos 152A-152B. Also as discussed above in relation to FIG. 3A, the threshold criterion may include the portion of the first video 152A that corresponds to the first video artifact and the portion of the second video 152B that corresponds to the second video artifact having a visual difference above a threshold visual difference value.

At block 530, processing logic causes a UI to play a first portion of the first video that includes the first video artifact and a second portion of the second video that includes the second video artifact. In one embodiment, the UI may include the UI 400 of FIG. 4A. Playing the first portion of the first video may include the UI 400 playing the first video portion 410A, and playing the second portion of the second video may include the UI 400 playing the second video portion 410B. As discussed above, the UI 400 may synchronize the playback of the first and second video portions 410A-410B so the video portions 410A-410B depict substantially the same content at substantially the same time so the viewing user can compare the video artifacts depicted in the video portions 410A-410B.

In one embodiment, the first video portion 410A of the first video 152A may include one or more first ROIs within one or more frames of the first video 152A. The second video portion 410B of the second video 152B may include one or more second ROIs within one or more frames of the second video 152B. The ROIs may include sections of the one or more frames of the respective videos 152A-152B. The video portions 410A-410B may include ROIs instead of entire frames of the videos 152A-152B so the viewing user can quickly see the video artifacts depicted in the video portions 410A-410B and so the user is not distracted by non-artifact content 416 of the videos 152A-152B.

In some embodiments, causing the UI 400 to play the first video portion 410A and the second video portion 410B may include causing the UI 400 to repeatedly play each of the first portion 410A and the second video portion 410B in a forward playback and a reverse playback. For example, as discussed above in relation to FIG. 4A, the user may interact with the forward-reverse UI element 424 of the UI 400, which may cause the video portions 410A-410B to play in alternating forward and backward directions. Playing the video portions 410A-410B in a forward-reverse manner may make it easier for the viewing user to see and evaluate certain video artifacts 414A-414B.

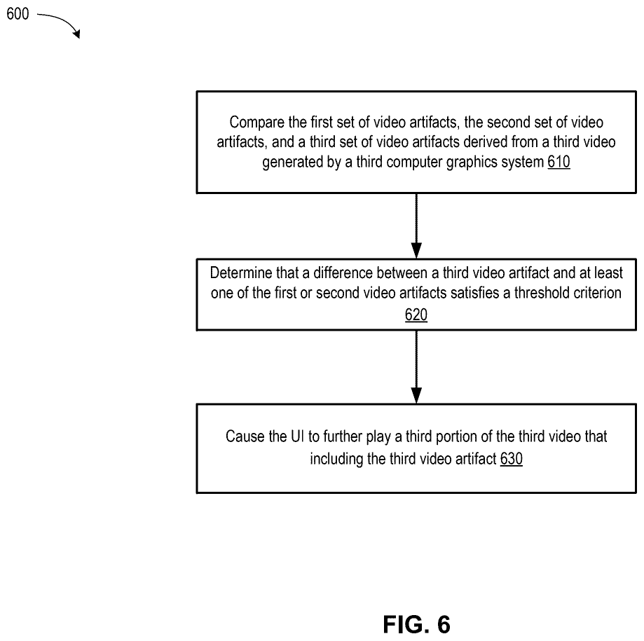

FIG. 6 is a flow diagram of a method 600 of performing video comparisons for the evaluation of computer graphics systems, according to at least one embodiment. The method 600 may be performed using one or more processing units or devices (e.g., CPUs, GPUs, accelerators, PPUs, DPUs, etc.), which may include (or communicate with) one or more memory devices. In at least one embodiment, the method 600 may be performed using processing units of the video comparison server 102. In at least one embodiment, the processing units performing the method 600 may be executing instructions stored on non-transient computer-readable storage media. In at least one embodiment, the method 600 may be performed using multiple processing threads (e.g., CPU threads and/or GPU threads), individual threads executing one or more individual functions, routines, subroutines, or operations of the method. In at least one embodiment, processing threads implementing the method 600 may be synchronized (e.g., using semaphores, critical sections, and/or other thread synchronization mechanisms). Alternatively, processing threads implementing the method 600 may be executed asynchronously with respect to each other. Some operations of the method 600 may be performed in a different order compared with the order shown in FIG. 6. Some operations of the method 600 may be performed concurrently with other operations. In at least one embodiment, one or more operations shown in FIG. 6 may not always be performed. One or more operations of the method 600 may be performed by video comparison system 120. The method 600 may include operations in addition to the operations 510-530 of the method 500 of FIG. 5.

At block 610, processing logic compares the first set of video artifacts, the second set of video artifacts, and a third set of video artifacts. The third set of video artifacts may include one or more video artifacts derived from a third video generated by a third computer graphics system. The first set of video artifacts may include the first set of video artifacts of block 510 of the method 500. The second set of video artifacts may include the second set of video artifacts of block 510. The third set of video artifac152ts may include video artifacts indicated by the third video artifact data 154C of FIG. 3B. The third video generated by the third computer graphics system may include the third video 152C. The third set of video artifacts may include video artifacts identified by a computational model that identifies video artifacts in video data (e.g., the artifact identification model 162). Comparing the first, second, and third set of video artifacts may include the video comparison module 210 comparing the first, second, and third sets of video artifacts.

At block 620, processing logic determines, based on the comparing of the first, second, and third sets of video artifacts, that a difference between a third video artifact and at least one of the first video artifact or the second video artifact satisfies the threshold criterion. The first, second, and third video artifacts may have one or more similar characteristics. As discussed above in relation to FIG. 3B, the first video artifact, the second video artifact, and the third video artifact may occur during the same content depicted in the first, second, and third videos 152A-152C. Also as discussed above in relation to FIG. 3B, the threshold criterion may include at least one of (1) the portion of the third video 152C that corresponds to the third video artifact and the portion of the first video 152A that corresponds to the first video artifact having a visual difference above a threshold visual difference value, or (2) the portion of the third video 152C that corresponds to the third video artifact and the second video 152B that correspond to the second video artifact having a visual difference above the threshold visual difference value.

At block 630, processing logic causes the UI to further play a third portion of the third video comprising the third video artifact. The UI may include the UI 440 of FIG. 4B. The third portion of the third video may include the video portion 410C. The third video artifact may include the video artifact 414C. The UI 440 may synchronize the playback of the first, second, and third video portions 410A-410C so the video portions 410A-410C depict substantially the same content at substantially the same time so the viewing user can compare the video artifacts depicted in the video portions 410A-410C.

### Inference and Training Logic

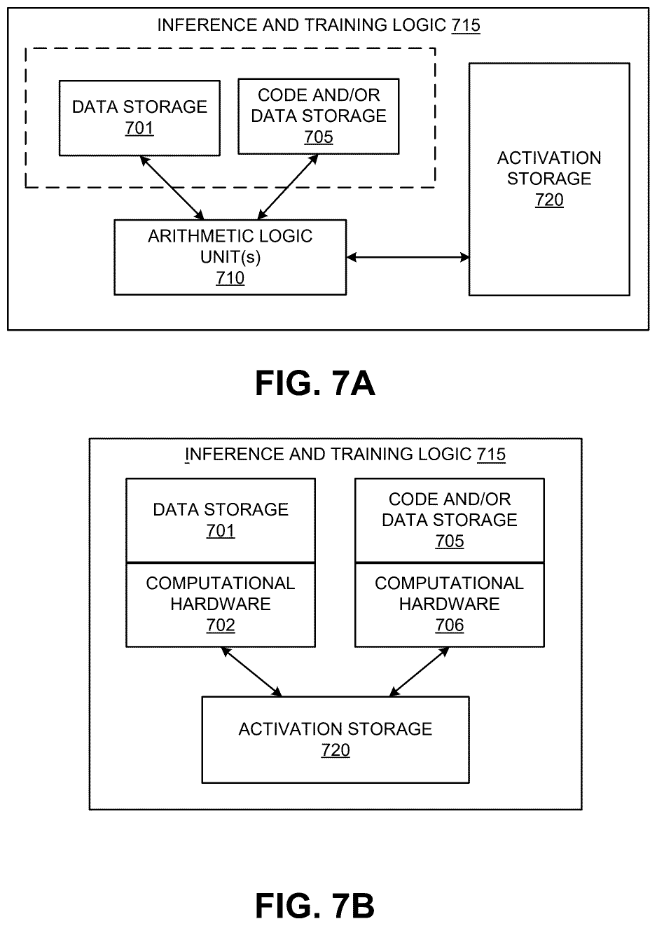

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

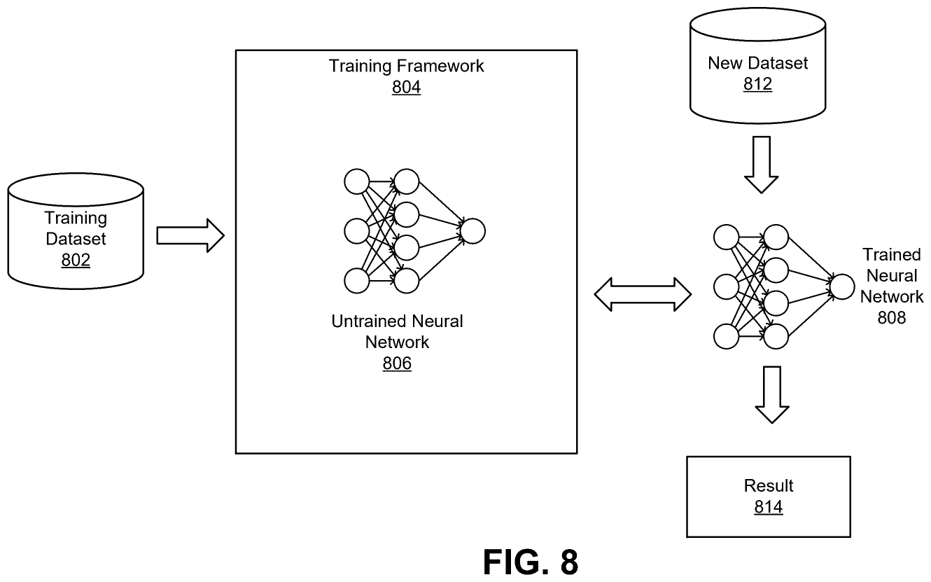

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

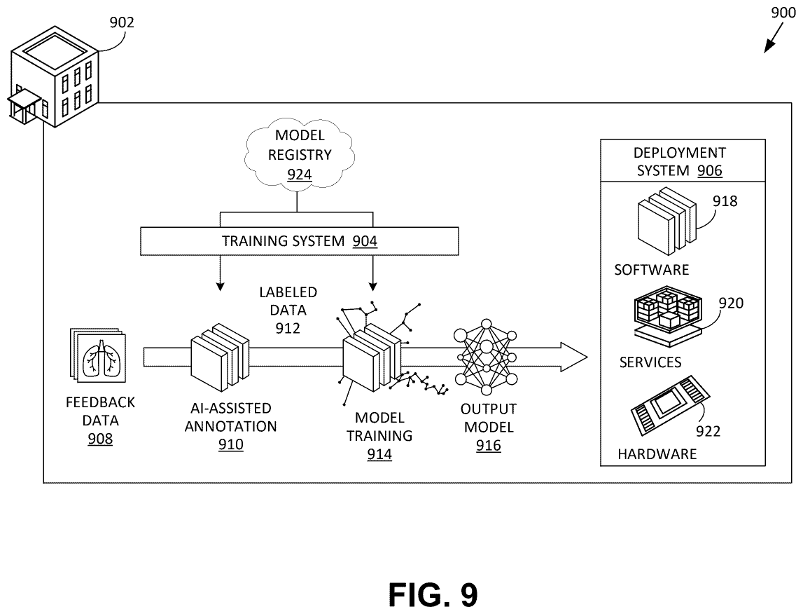

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

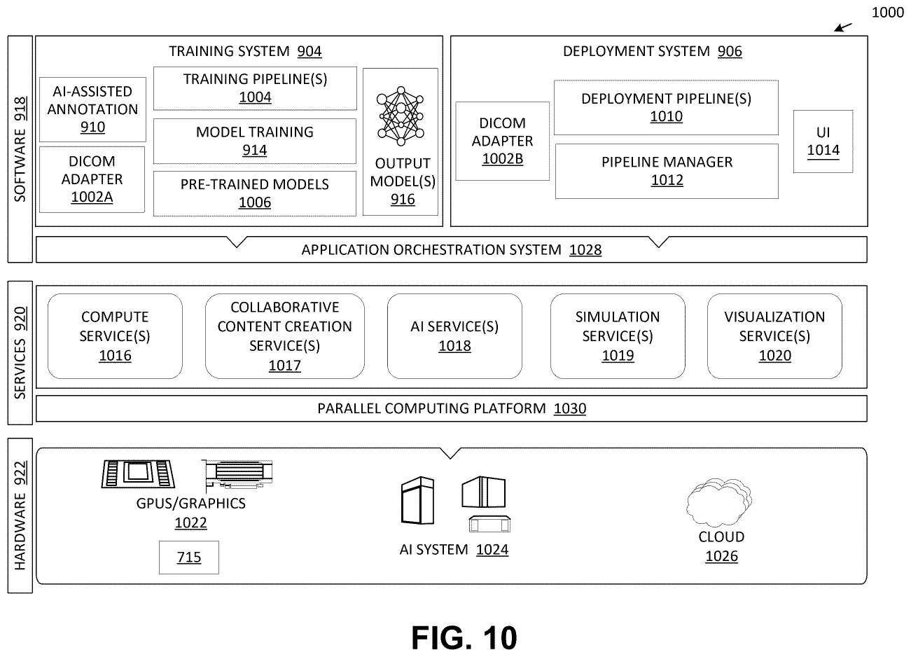

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high-performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

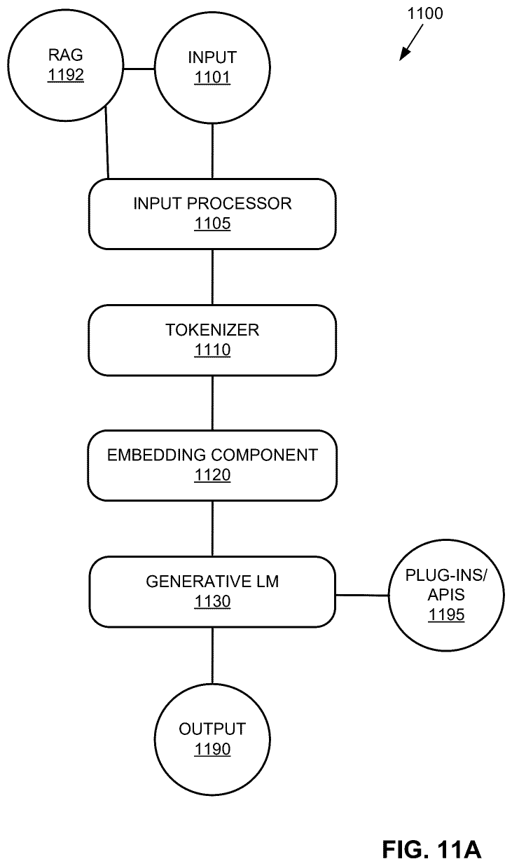

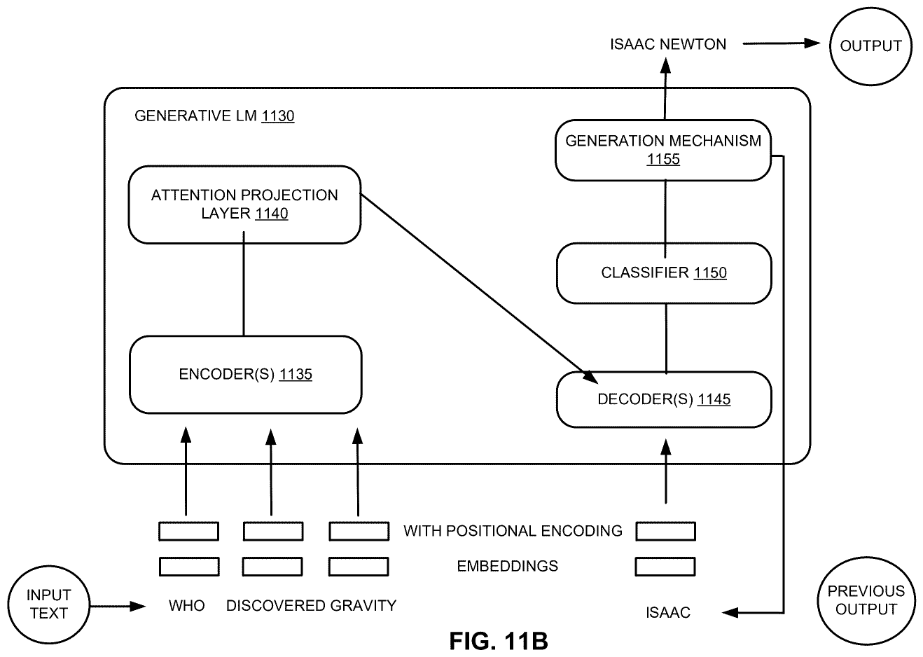

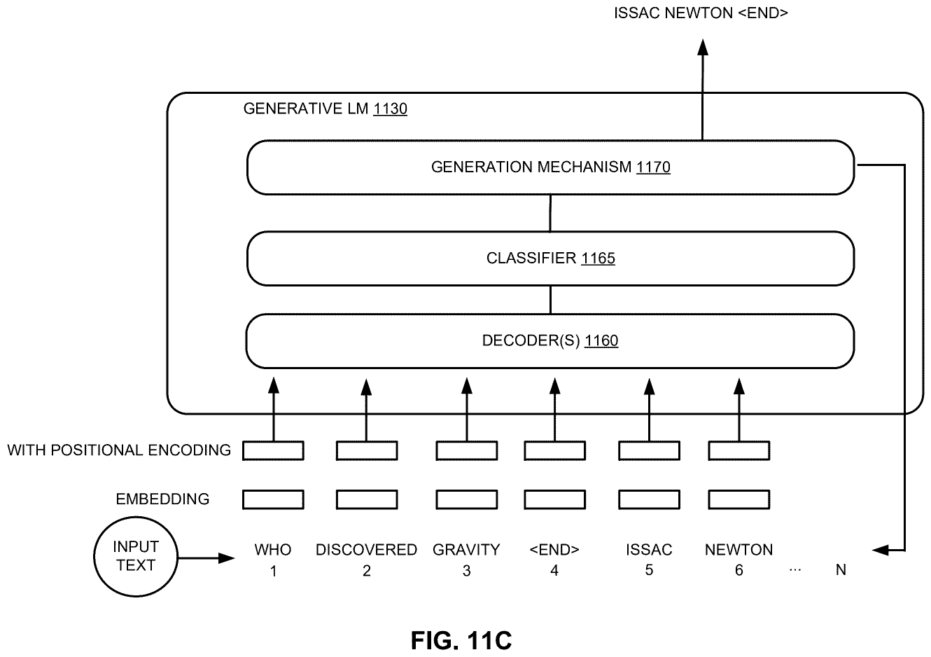

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an a large LM (LLM), a small LM (SLM), a vision LM (VLM), a multi-modal LM (MMLM), etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text cleaning to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features-such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder, according to at least one embodiment. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture, according to at least one embodiment. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

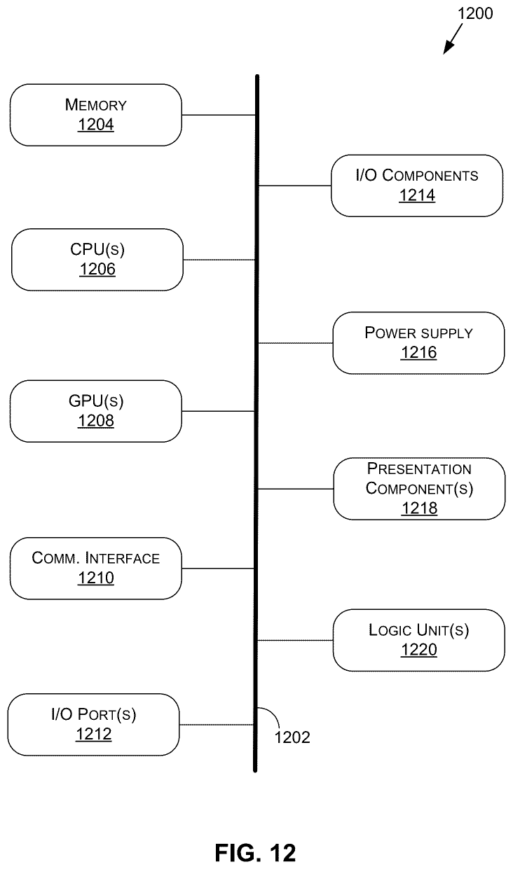

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

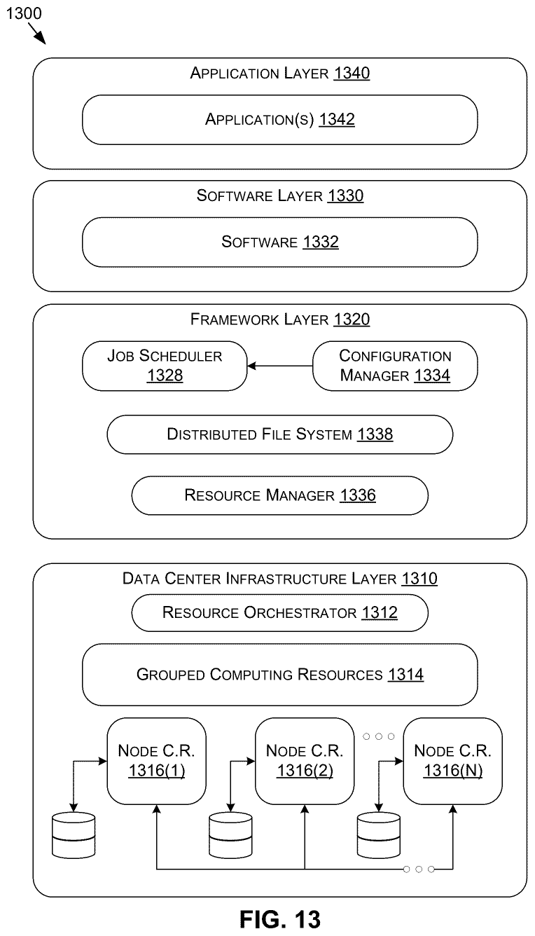

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-1316(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
comparing, using a processing device, a first set of video artifacts derived from a first video generated by a first computer graphics system and a second set of video artifacts derived from a second video generated by a second computer graphics system;
determining, based on the comparing, that a difference between a first video artifact from the first set of video artifacts and a second video artifact from the second set of video artifacts satisfies a threshold criterion, wherein the first video artifact and the second video artifact have one or more similar characteristics; and
causing a user interface (UI) to display a first portion of the first video comprising the first video artifact and a second portion of the second video comprising the second video artifact.

2. The method of claim 1, wherein the first video and the second video each comprises at least one of:
computer-generated animation;
video of video game gameplay; or
a pre-rendered cutscene.

3. The method of claim 1, wherein the first set of video artifacts comprises one or more video artifacts identified by a computation model that identifies video artifacts in video data.

4. The method of claim 1, wherein the first video artifact comprises at least one of:
flickering;
ghosting; or
pixelation.

5. The method of claim 1, wherein:
the first portion of the first video comprises a first plurality of regions of interest (ROIs) within a plurality of frames of the first video; and
the second portion of the second video comprises a second plurality of ROIs within a plurality of frames of the second video.

6. The method of claim 1, wherein causing the UI to display the first portion and the second portion comprises causing the UI to play each of the first portion and the second portion in a forward playback and a reverse playback.

7. The method of claim 1, wherein the first video artifact and the second video artifact having the one or more similar characteristics comprises the first video artifact and the second video artifact corresponding to the same content of the first video and the second video.

8. The method of claim 1, wherein the method further comprises:
comparing, using the processing device, the first set of video artifacts, the second set of video artifacts, and a third set of video artifacts derived from a third video generated by a third computer graphics system;
determining, based on the comparing of the first, second, and third sets of video artifacts, that a difference between a third video artifact from the third set of video artifacts and at least one of the first video artifact or the second video artifact satisfies the threshold criterion, wherein the first, second, and third video artifacts have one or more similar characteristics; and
causing the UI to further display a third portion of the third video comprising the third video artifact.

9. A system comprising:
one or more processors to perform operations comprising:
comparing a first set of video artifacts derived from a first video generated by a first computer graphics system and a second set of video artifacts derived from a second video generated by a second computer graphics system;
determining, based on the comparing, that a difference between a first video artifact from the first set of video artifacts and a second video artifact from the second set of video artifacts satisfies a threshold criterion, wherein the first video artifact and the second video artifact have one or more similar characteristics; and
causing a user interface (UI) to synchronize a playback of a first portion of the first video comprising the first video artifact and a second portion of the second video comprising the second video artifact.

10. The system of claim 9, wherein the first video and the second video each comprises at least one of:
computer-generated animation;
video of video game gameplay; or
a pre-rendered cutscene.

11. The system of claim 9, wherein the first set of video artifacts comprises one or more video artifacts identified by a computation model that identifies video artifacts in video data.

12. The system of claim 9, wherein the first video artifact comprises at least one of:
flickering;
ghosting; or
pixelation.

13. The system of claim 9, wherein:
the first portion of the first video comprises a first plurality of regions of interest (ROIs) within a plurality of frames of the first video; and
the second portion of the second video comprises a second plurality of ROIs within a plurality of frames of the second video.

14. The system of claim 9, wherein causing the UI to synchronize the playback of the first portion and the second portion comprises causing the UI to play each of the first portion and the second portion in a forward playback and a reverse playback.

15. The system of claim 9, wherein the first video artifact and the second video artifact having the one or more similar characteristics comprises the first video artifact and the second video artifact corresponding to the same content of the first video and the second video.

16. The system of claim 9, wherein the operations further comprise:
comparing, using the processing device, the first set of video artifacts, the second set of video artifacts, and a third set of video artifacts derived from a third video generated by a third computer graphics system;
determining, based on the comparing of the first, second, and third sets of video artifacts, that a difference between a third video artifact from the third set of video artifacts and at least one of the first video artifact or the second video artifact satisfies the threshold criterion, wherein the first, second, and third video artifacts have one or more similar characteristics; and
causing the UI to further synchronize a playback of a third portion of the third video comprising the third video artifact.

17. At least one processor comprising processing circuitry to:
compare one or more first video artifacts derived from a first video generated by a first computer graphics system and one or more second video artifacts derived from a second video generated by a second computer graphics system;
determine, based on the comparing, that a difference between a first video artifact from the one or more first video artifacts and a second video artifact from the one or more second video artifacts satisfies a threshold criterion; and
cause a user interface (UI) to synchronously display a first portion of the first video comprising the first video artifact and a second portion of the second video comprising the second video artifact.

18. The at least one processor of claim 17, wherein:
the first portion of the first video comprises a first plurality of regions of interest (ROIs) within a plurality of frames of the first video; and
the second portion of the second video comprises a second plurality of ROIs within a plurality of frames of the second video.

19. The at least one processor of claim 17, wherein causing the UI to synchronously display the first portion and the second portion comprises causing the UI to play each of the first portion and the second portion in a forward playback and a reverse playback.

20. The at least one processor of claim 17, wherein the threshold criterion is based on a metric that quantifies visual similarity between the first video artifact and the second video artifact.
